(19) United States
(12) Patent Application Publication
(10) Pub. No.: US 2006/0276216 A1
(43) Pub. Date: Dec. 7, 2006

(54) Apparatus and methods for information handling system with dynamic output power

(76) Inventor: Jason Tongen, Austin, TX (US)

Correspondence Address: O'KEEFE, EGAN & PETERMAN, 1101 CAPITAL OF TEXAS HIGHWAY SOUTH, #C200, AUSTIN, TX, 78746, US

(21) Appl. No.: 11/142,141

(22) Filed: Jun. 1, 2005

(51) Int. Cl. H04Q 7/30

(52) U.S. Cl. 455/522; 455/69

(57) ABSTRACT

An information handling system includes at least one or more base stations. The base station(s) provide the information handling system with wireless communication capability. The base station(s) have the ability to vary their output power(s). The base station(s) set their output power(s) in response to a desired set of criteria, which include the number of connections to one or more mobile clients.

### TECHNICAL FIELD

The inventive concepts relate generally to information handling apparatus and systems. More particularly, the invention concerns apparatus and associated methods for dynamically configuring the output or transmit power of information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In one type of networking/communication system, transceivers or base stations communicate with mobile clients. The base stations handle network traffic with the mobile clients. Some base stations, however, may end up servicing a relatively large number of clients while other base stations may experience under-utilization. This situation can result in uneven distribution of the network load across base stations. A need therefore exists for techniques for more evenly loading the base stations and thus providing better service to the corresponding clients.

### SUMMARY

The disclosed novel concepts relate to information handling systems that may include base stations with dynamic or varying output power. In one embodiment, an information handling system includes at least one or more base stations. The base station(s) provide the information handling system with wireless communication capability. The base station(s) have the ability to vary their output power(s). The base station(s) set their output power(s) in response to a desired set of criteria, which include the number of connections with one or more mobile clients.

In another embodiment, a base station includes a transmitter and an output power calculator. The output power calculator couples to the transmitter. The output power calculator is configured to set the output power of the base station, provided by the transmitter. The output power calculator sets the output power in response to a set of criteria, including a number of connections with one or more mobile clients.

### BRIEF DESCRIPTION OF THE DRAWINGS

The appended drawings illustrate only exemplary embodiments of the invention and therefore should not be considered or construed as limiting its scope. Persons of ordinary skill in the art who have the benefit of the description of the invention appreciate that the disclosed inventive concepts lend themselves to other equally effective embodiments. In the drawings, the same numeral designators used in more than one drawing denote the same, similar, or equivalent functionality, components, or blocks.

FIG. 1 shows an information handling system 100 according to an exemplary embodiment of the invention

FIG. 2 illustrates a circuit arrangement relating to a base station, according to an exemplary embodiment of the invention

FIG. 3 depicts a network arrangement that includes at least one base station according to an illustrative embodiment of the invention.

FIG. 4 shows the network arrangement of FIG. 3, with the output power of a base station reduced.

FIG. 5 illustrates a simplified block diagram of a base station according to an illustrative embodiment of the invention.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

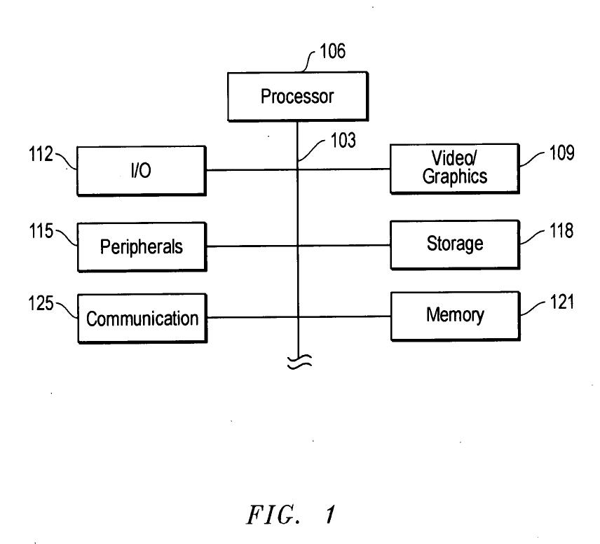

FIG. 1 shows an information handling system 100 according to an exemplary embodiment of the invention. Generally speaking, system 100 may constitute a host or server computer system, workstation, and the like, as desired. System 100 includes one or more processors 106, one or more buses or communication media 103, video/graphics hardware 109, storage subsystem 118, memory 121, input/output (I/O) 112, peripherals 115, and communication apparatus 125.

Bus 103 provides a mechanism for the various components of system 100 to communication and couple with one another and thus acts as the backbone of the system. Processor 106, video/graphics 109, storage subsystem 118, memory 121, I/O 112, communications apparatus 125, and peripherals 115 have the structure, and perform the functions, familiar to persons of ordinary skill in the art who have the benefit of the description of the invention.

Note that FIG. 1 provides merely an illustrative and simplified block diagram or architecture of system 100. One may readily use alternative architectures or structures, and yet take advantage of the inventive concepts, by making modifications that fall within the knowledge of persons of ordinary skill in the art who have the benefit of the description of the invention.

Communication apparatus may include a variety of networking circuitry, as desired. Such networking circuitry may include local area networks (LAN). The network arrangement may have a plurality (generally N) of base stations (not shown explicitly in FIG. 1). Each of the base stations may communicate with one or more mobile clients.

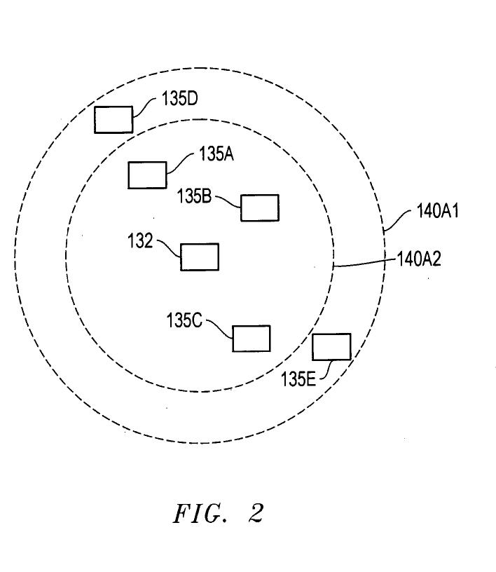

FIG. 2 shows a circuit arrangement relating to a base station, according to an exemplary embodiment of the invention. The circuit arrangement in FIG. 2 includes base station 132 and one or more mobile clients 135A-135F. At any given time, base station 132 may communicate with one or more of mobile clients 135A-135F.

Base station 132 and the mobile client(s) may communicate in a number of ways, as desired, and as persons of ordinary skill in the art who have the benefit of the description of the invention understand. For example, the communication may use the well-known IEEE 802.11(a), IEEE 802.11(b), or IEEE 802.11(g), as desired. The choice of communication mechanism and protocol depends on a number of factors, as persons of ordinary skill in the art who have the benefit of the description of the invention understand. Such factors include the available equipment, the desired performance and design specifications, and the like.

The number of mobile clients 135A-135F with which base station 132 communicates depends on a variety of factors. One of those factors constitutes the output power level of base station 132. More specifically, suppose that base station 132 has a relatively high output power level. At such a power level, base station 132 may have a range denoted by dashed curve 140A1. At that power level, base station 132 can communicate with all of the mobile clients shown, i.e., mobile clients 135A-135E.

Now, suppose that the output power of base station 132 decreases. At such a decreased power level, base station 132 may have a range denoted by dashed curve 140A2. At that power level, base station 132 no longer communicates with all of the mobile clients. Rather, base station 132 communicates with or connects to a subset of mobile clients 135A-135F. In the example shown, base station 132 communicates with mobile clients 135A-135C (i.e., mobile clients 135A-135C connect to base station 132). Put another way, because of the decreased power level, base station 132 disconnects from and will not connect to mobile clients 135D-135E.

To summarize, as the output power level of base station 132 varies, the number of mobile clients 135A-135E connected to, or capable of communicating with, base station 132 changes. In other words, the load on base station 132, i.e., the number of mobile clients with which it connects, associates, or communicates, varies based, among other things, on the output power level of base station 132. By reducing its output power level, base station 132 can reduce its load level (i.e., the number of mobile clients connected to it or capable of connecting to it or communicating with it), and vice-versa.

As the load of base station 132 decreases, the burden of serving mobile clients decreases, thus preventing or avoiding the excessive loading or over-burdening of base station 132. Furthermore, decreasing the load of base station 132 will reduce the number of potential new mobile clients that base station 132 is willing to accept and will reserve the theoretical bandwidth and/or other limited resources on a stressed base station to clients that are close to it. Clients outside the rage of the stressed base station will have to connect to other less-stressed base stations.

base station 132 may decrease its output power based on a wide variety of parameters or variables, described below in detail. For example, base station 132 may decrease its output power when the number of mobile clients connected to it exceeds a desired or prescribed threshold. As another example, base station 132 may decrease its output power when the number of requests from mobile clients for connection with base station 132 exceed a desired or prescribed threshold.

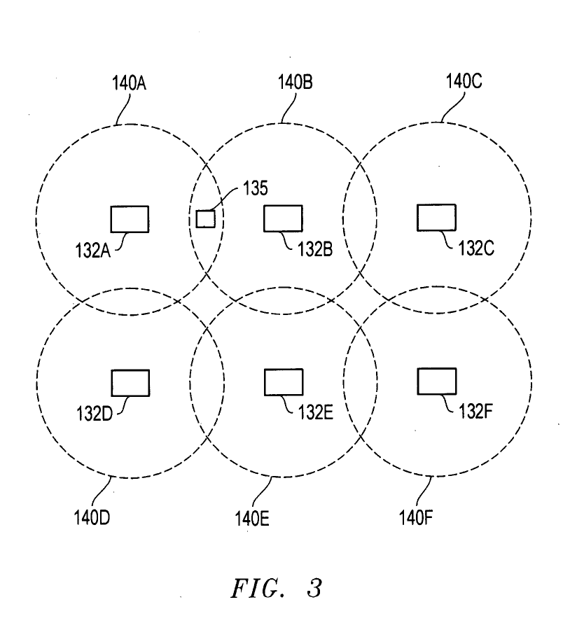

FIG. 3 shows a network arrangement that includes at least one base station according to an illustrative embodiment of the invention. More specifically, the arrangement in FIG. 3 includes base stations 132A-132F. Each base station has a corresponding range, denoted by dashed paths 140A-140F. The network may include one or more mobile clients, such as mobile client 135. Mobile client 135 may be within the range of one or more base stations. For example, mobile client 135 may fall within the range of base stations 132A and 132B.

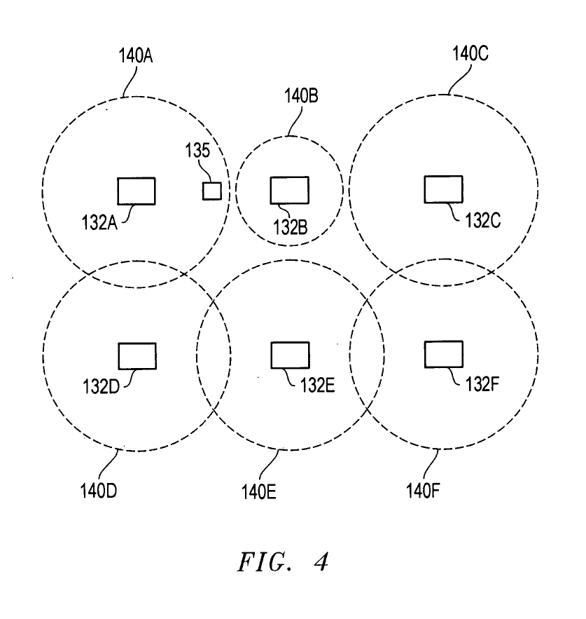

If one of the base stations, say, base station 132B reduces its output power, its corresponding range will diminish, as described above in detail. As a result, mobile client 135 may no longer fall within the range of base station 132B. Thus, mobile client 135 may establish a connection with another base station, say, base station 132A, within the range of which it falls. FIG. 4 illustrates such a situation (i.e., the network arrangement of FIG. 3, with the output power of base station 132B reduced).

In the particular context of an IEEE 802.11 network, the specifications refer to access points (APs) and associations, rather than, respectively, base stations and connections, as used generally in the description of the inventive concepts. In an IEEE 802.11 network, a mobile client attempts to make an association to an AP according to prescribed procedures. More specifically, the client initiates the process by issuing a probe request to the AP. Any AP within the range of the client may respond with a probe response. The client can then process all received probe responses from the AP that are members of a target or desired network and within range. The client then may request an association with any one of those APs.

For example, suppose that the network arrangement in FIG. 3 operates according to 802.11 standards. Mobile client 135 may send probe requests to all APs. Suppose that APs 132A and 132B fall within the range of mobile client 135. Suppose further that AP 132B does not wish to establish a connection with mobile client 135 (e.g., because AP 132B has too many connections, the number of probe requests exceeds a threshold, or it otherwise experiences an excessive burden).

Under such circumstances, AP 132B may reduce its output power. By reducing its output power, AP 132B may avoid a connection request from a given client, such as mobile client 135. More specifically, as AP 132B reduces its output power, it fails to be within the range of mobile client 135. As a result, mobile client 135, seeking to associate with an AP within the network, will not request a connection to AP 132B. Instead, mobile client will request to establish a connection with another AP in the network, e.g., AP 132A.

Note that, in addition to probe frames, one may readily apply the inventive concepts to other communication constructs, as persons of ordinary skill in the art who have the benefit of the description of the invention understand, and as desired. Examples include association response frames, probe response frames, data frames, beacon frames, and the like exceeding thresholds or other criteria associated with them.

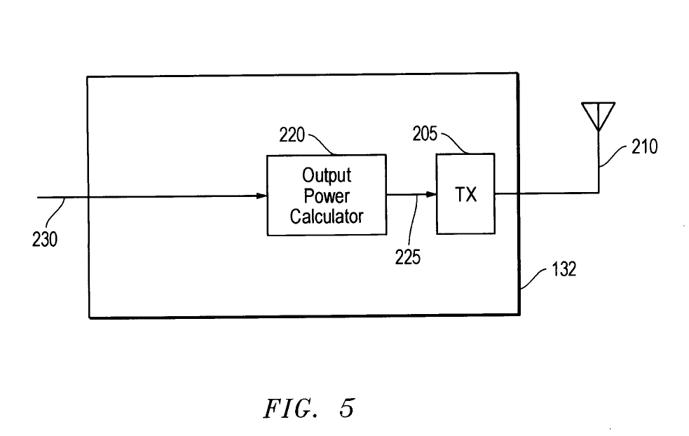

FIG. 5 shows a simplified block diagram of a base station 132 according to an illustrative embodiment of the invention: The simplified block diagram of base station 132 includes output power calculator 220, transmitter (TX) 205, and antenna 210.

Output power calculator 220 includes circuitry that calculates the desired output power level of base station 132 and provides that information to transmitter 205 via signal link 225. Transmitter 205 transmits a signal with the desired power level via antenna 210.

Output power calculator 220 may take a number of varies and parameters into account in calculating the desired output power level. Examples include the number of connected mobile clients, throughput, total bandwidth available, demand from one or more of the mobile clients and their respective ranges, resources available (e.g., buffer size, number of connections), signal strength, signal quality, power consumption (for example, in battery-powered applications), and the like.

In addition, via signal link 230, output power calculator 220 may use one or more signals external to base station 132 in order to calculate the desired output power of base station 132. In this manner, calculator 220 may take into consideration system-level parameters and variables, as desired.

Furthermore, rather than using output power calculator 220 to adjust the output power of base station 132, station 132 may take other actions, as desired. For example, base station 132 may deny requests for connections when it experiences an over-burdened or excessive-load condition. As another example, base station 132 may cease to transmit altogether (i.e., output power calculator 220 causes transmitter 205 to shut down or not transmit).

Persons of ordinary skill in the art who have the benefit of the description of the invention appreciate that FIG. 5 merely shows a simplified block diagram of base station 132. Base station 132 may include a variety of other circuitry, with a multitude of functionality, as desired. Some examples of such circuitry include receive (RX) circuitry, signal processing circuitry, encoders, decoders, modulators, demodulators, error-correction circuitry, and the like.

Referring to the figures, persons of ordinary skill in the art will note that the various blocks shown may depict mainly the conceptual functions and signal flow. The actual circuit implementation may or may not contain separately identifiable hardware for the various functional blocks and may or may not use the particular circuitry shown. For example, one may combine the functionality of various blocks into one circuit block, as desired. Furthermore, one may realize the functionality of a single block in several circuit blocks, as desired. The choice of circuit implementation depends on various factors, such as particular design and performance specifications for a given implementation, as persons of ordinary skill in the art who have the benefit of the description of the invention understand. Other modifications and alternative embodiments of the invention in addition to those described here will be apparent to persons of ordinary skill in the art who have the benefit of the description of the invention. Accordingly, this description teaches those skilled in the art the manner of carrying out the invention and are to be construed as illustrative only.

The forms of the invention shown and described should be taken as the presently preferred or illustrative embodiments. Persons skilled in the art may make various changes in the shape, size and arrangement of parts without departing from the scope of the invention described in this document. For example, persons skilled in the art may substitute equivalent elements for the elements illustrated and described here. Moreover, persons skilled in the art who have the benefit of this description of the invention may use certain features of the invention independently of the use of other features, without departing from the scope of the invention.

1. An information handling system, comprising at least one base station, wherein the at least one base station sets its output power in response to a desired set of criteria, including a number of connections with one or more mobile clients.

2. The information handling system according to claim 1, wherein the at least one base station reduces its output power when the number of connections with one or more mobile clients exceeds a threshold.

3. The information handling system according to claim 1, wherein the at least one base station reduces its output power when a number of requests for connection from one or more mobile clients exceeds a threshold.

4. The information handling system according to claim 2, wherein reducing the output power of the at least base station decreases a corresponding range of the at least one base station.

5. The information handling system according to claim 4, wherein decreasing the output power of the at least one base station causes the at least one base station to disconnect from the at least one mobile client.

6. The information handling system according to claim 1, wherein the at least one base station ceases transmission when the number of connections to one or more mobile clients exceeds a threshold.

7. The information handling system according to claim 1, wherein the at least one base station ceases transmission of one or more frames when the number of connections one or more mobile clients exceeds a threshold.

8. The information handling system according to claim 2, wherein the at least one base stations comprises an access point that conforms to an 802.11 communication standard.

9. The information handling system according to claim 8, wherein at least one mobile client in the one or more mobile clients conforms to an 802.11 communication standard.

10. The information handling system according to claim 3, wherein the at least one base station comprises an access point that conforms to an 802.11 communication standard.

11. The information handling system according to claim 10, wherein at least one mobile client in the one or more mobile clients conforms to an 802.11 communication standard.

12. A base station, comprising:
a transmitter; and
an output power calculator coupled to the transmitter, the output power calculator configured to set an output power of the base station provided by the transmitter,
wherein the output power calculator sets the output power in response to a set of criteria, including a number of connections to one or more mobile clients.

13. The base station according to claim 12, wherein the output power calculator is configured to reduce the output power when the number of connections to the one or more mobile clients exceeds a threshold.

14. The base station according to claim 12, wherein the output power calculator is configured to reduce the output power when a number of requests for connection from one or more mobile clients exceeds a threshold.

15. The base station according to claim 12, further comprising an antenna coupled to the transmitter.

16. The base station according to claim 12, wherein the output power calculator couples to the transmitter through a first signal link.

17. The base station according to claim 16, wherein the output power calculator at least one criterion in the set of criteria through a second signal link.

18. The base station according to claim 12, wherein the base station comprises an access point configured to conform to an 802.11 communication standard.

19. The base station according to claim 18, wherein the output power calculator is configured to reduce the output power when a number of probe requests exceeds a threshold.

20. The base station according to claim 12, wherein the set of criteria includes one or more of throughput, available bandwidth, demand from one or more mobile clients, ranges of one or more mobile clients, available resources, signal strength, signal quality, and power consumption.
